(19) United States
(12) Patent Application Publication
(10) Pub. No.: US 2012/0005961 A1
(43) Pub. Date: Jan. 12, 2012

(54) Revolving Door

(75) Inventors: Sven BUSCH, Dortmund (DE); Michael Glanz, Langenfeld (DE); Thomas Schmitz, Wesseling (DE)

(73) Assignee: Dorma GmbH + Co. KG, Ennepetal (DE)

(21) Appl. No.: 13/163,428

(22) Filed: Jun. 17, 2011

(30) Foreign Application Priority Data
Jun. 17, 2010 (DE) 10 2010 024 108.3

(51) Int. Cl. E06B 5/00; E05F 15/10

(52) U.S. Cl. 49/46

(57) ABSTRACT

A revolving door that has a drive, which is operatively connected to a turnstile of the revolving door and rotationally drives the turnstile. The drive includes a drive motor configured as a multipole electro-motor, the axis of rotation thereof extending parallel or coaxially to the axis of rotation of the turnstile and has a height of equal to or smaller than 80 mm.

### BACKGROUND OF THE INVENTION

1. Field of the Invention

The invention relates to an automated revolving door that is provided with a motor drive.

2. Description of the Related Art

A revolving door system is known from EP 2 072 737 A2, which has a motor drive in a canopy structure above the turnstile of the revolving door system. The turnstile is formed by a rotating column with the revolving door leaves attached thereto. A drive motor is operatively connected to the rotating column via an output shaft and a reversing gear. The output shaft extends approximately vertically to the longitudinal extension of the rotating column.

Due to the immense torque that the drive needs to apply for rotating the turnstile of such a door, the drive motors are relatively large dimensioned that results in enormous space requirements above or below the turnstile. Therefore, most of the time, the revolving door drives are installed above the turnstile, resulting in a visually unfavorable, high canopy structure.

### SUMMARY OF THE INVENTION

An object of the invention is to reduce the shortfalls of the state-of-the-art.

According to one embodiment of the invention, a revolving door has a drive operatively connected to a turnstile of the revolving door for rotationally driving this turnstile. The drive comprises a drive motor configured as a multipole electrical motor, the axis of rotation thereof extending parallel or coaxially to the axis of rotation of the turnstile, and has a height of equal to or smaller than 80 mm. The inventive drive can therefore be disposed in a floor portion of the revolving door, namely underfloor in such a way that no work needs to be performed in the unfinished floor of the building, into which the revolving door is to be incorporated.

Preferably the drive has a height of equal to or smaller than 60 mm. In conventional building floors, the unfinished floor has a cover layer at the height of at least 65 mm. If the cover layer is removed in the area of the drive, or if this layer is not provided at all in this area, the inventive drive has enough play in terms of height in the thus created reception space, and, with regard to the installation depth, it can be adjusted in the reception space configured in the cover layer without the drive reaching or even exceeding the delimitation of the reception space. The reception space is thus a portion of the floor into which the inventive drive is to be incorporated. The floor portion is thus disposed between the turnstile of the revolving door and an unfinished floor of a building. In this case, the floor portion bears against the unfinished floor, respectively is disposed above said unfinished floor.

Furthermore, the revolving door preferably has an adjusting device adapted to modify the insert position of the drive in the floor. It is thereby possible to adjust the drive with regard to the turnstile such that both elements can be brought into the aforementioned operative connection for driving.

Preferably, the adjusting device allows for a height adjustment of the drive in the floor, whereby the drive can be disposed at the right distance to the turnstile independently from the depth of the floor portion.

In addition or as an alternative, the adjusting device allows for adjusting an inclination of the drive with regard to the floor. The drive is thereby usable even with floors that are inclined with respect to the turnstile without having to take special measures for ensuring the operative connection between the turnstile and the drive.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention will become apparent from the following description of preferred embodiments, in which:

FIG. 1 is a revolving door according to a first embodiment of the invention with a floor opening in a section,

FIG. 2 is the revolving door of FIG. 1 with the closed floor being illustrated;

FIG. 3 is the drive of FIG. 1 with enlarged detail;

FIG. 4 is an arrangement with a revolving door according to a second embodiment of the invention; and

FIG. 5 is an arrangement with a revolving door according to a third embodiment of the invention.

### DETAILED DESCRIPTION OF THE PRESENTLY PREFERRED EMBODIMENTS

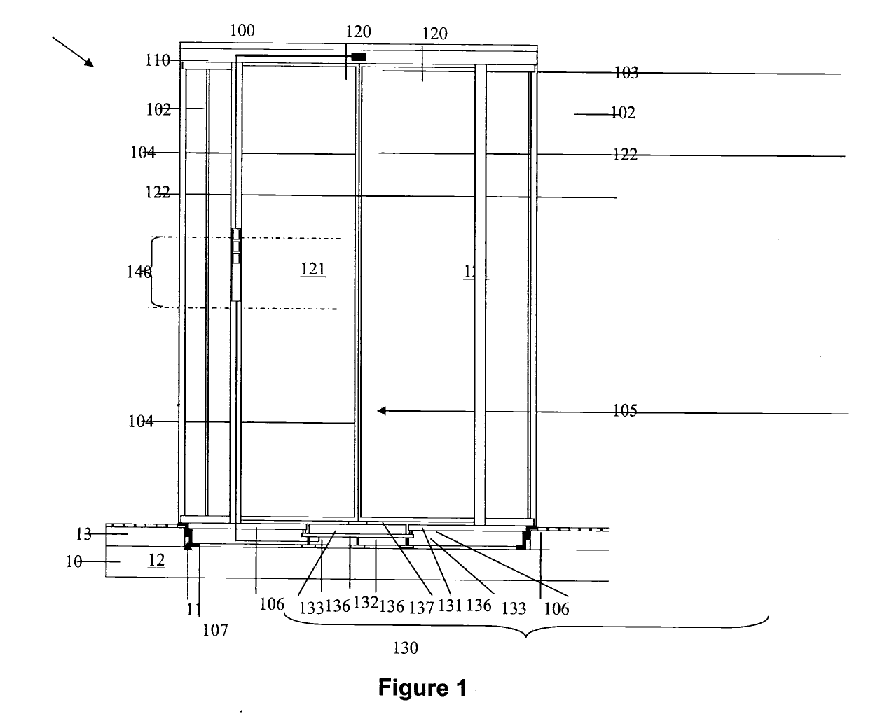

FIG. 1 shows a revolving door 100 according to a first embodiment of the invention. The revolving door 100 is conceived to be free standing. This means, it is incorporated as an autonomous component into a non-illustrated building. The revolving door 100 comprises a turnstile formed by a rotating column 105, to which several revolving leaves 120 are attached in a known manner. By way of example, the revolving leaves 120 are configured as glass door leaves, which respectively comprise a frame profile 122, in which a respective glass panel 121 is inserted. The rotating column 105, with the stationarily attached revolving leaves 120, is placed onto a drive 130 and accommodated to be freely rotational in the revolving door 100. The drive 130 is countersunk in a floor 10 of the building.

Essentially, the floor 10 comprises an unfinished floor 12 and a cover layer 13, in which a reception space, respectively a reception 11 is configured for the drive 130. In the present illustrated embodiment the cover layer 13 has been omitted in the area of the reception 11. As an alternative, the cover layer 13 is thinned in this area. The reception 11 may be configured as well by a casing, countersunk in the floor is open towards the revolving door 100. The cover layer 13 may be a screed topping, which is spread on the unfinished floor 12.

In the example shown, a reception casing 107, open to the top, i.e. towards the revolving door 100, is inserted into the reception 11. The drive 130 comprises a housing 131, in this case in the shape of a pot-shaped cover, which housing is placed onto a floor plate 132, which in turn in the present case is supported on the sub-floor of the reception casing 107 and therefore on the unfinished floor 12, via three visible support bolts 136. On the one hand, the support bolts 136 thus allow for adjusting the height of the drive 130, i.e. a vertical adjustment in FIG. 1, as long as all support bolts 136 are turned at the same time. On the other hand, by the support bolts 136, it is possible to likewise modify the inclination of the drive 130 with regard to the turnstile, respectively to the floor 10, and therefore to adapt it to the conditions on site, by only turning some of the support bolts 136.

At its upper side, the drive 130 has a cover disc 137, which protects the drive 130 against impurities in the area of the operative connection to the rotating column 105. In the upper lateral area in FIG. 1, the drive 130 is surrounded by another cover plate 106, which closes the remaining area of the reception casing 107 pointing towards the revolving door 100, to protect it against the ingress of dirt. Advantageously, in the area of the drive 130, the cover plate 106 is supported on support elements 133, which in turn are supported on the floor plate 132. Thereby, the shaft is reliably separated from the cover plate 106 across the entire area. At the right and left ends in FIG. 1 with respect to the drive 130, the cover plate 106 is placed on top of the upper border portions of the reception casing 107 in a sealing manner. For controlling the drive 130, it is coupled to a control panel 140 via one or more cable(s) 104, which panel 140, via another cable or again via more cables 104, is coupled to a sensor 103 disposed in the upper area of the revolving door 100. In one embodiment, the sensor 103 may be foregone. In this case, the sensor 103 is disposed in a canopy 110, respectively in a canopy structure of the revolving door 100. On the outside towards the right and the left sides in FIG. 1, the revolving door 100 is surrounded, respectively enclosed by drum walls 102. As can be seen, the control panel 140 is disposed in the left drum wall 102 of the revolving door 100 and allows by way of example, independently from a potential activation by the sensor 103, to stop or to move the revolving door 100.

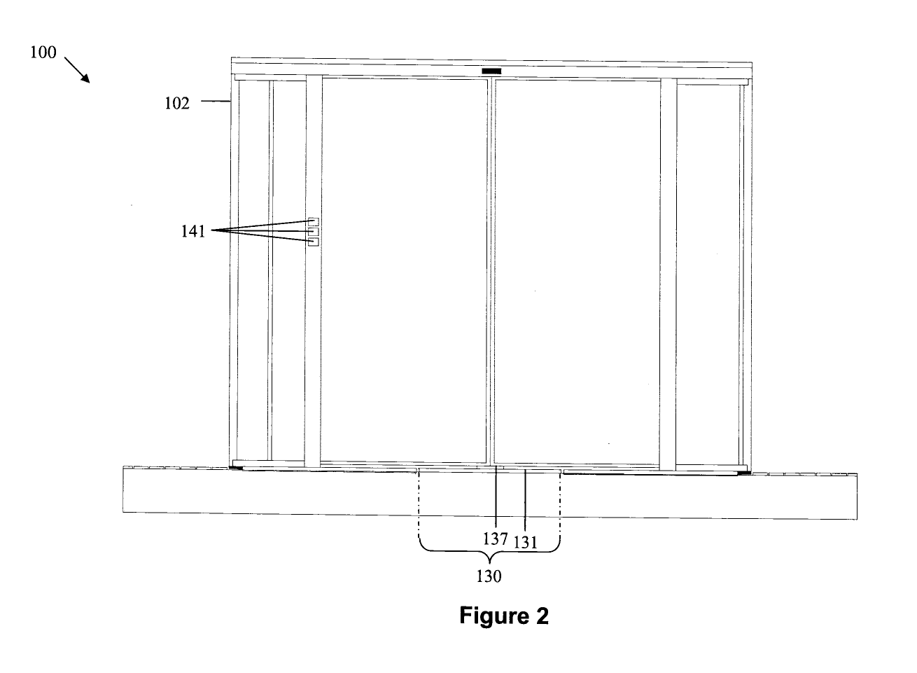

FIG. 2 shows the revolving door 100 of FIG. 1, wherein the drive 130 is visible only by the housing 131 and the upper cover plate 137. In the illustrated example, the control panel 140, not explicitly identified in this case, comprises three elements 141, which are configured for example as 55 mm inserts and may have any configuration, (switch, display, sensor, and the like).

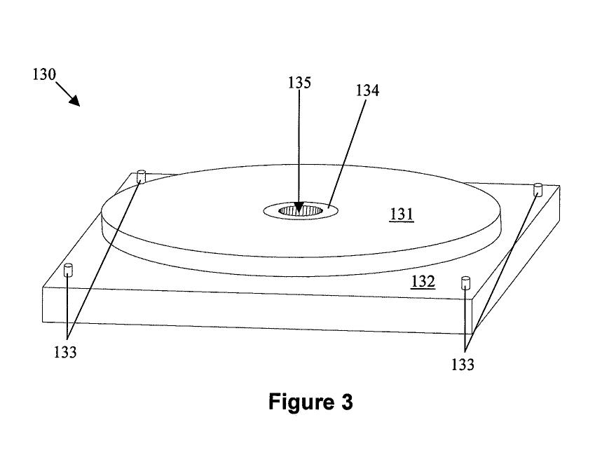

FIG. 3 shows the drive 130 in enlarged detail. The floor plate 132 can be particularly clearly seen, onto which both the support elements 133 and the housing 131 are placed. In the centre, the housing 131 is configured to be open to the top. A shaft member 134 is disposed in this area, which is operatively connected and rotating along with the turnstile, which is not illustrated in this figure. In the centre, the shaft member 134 has a turnstile-coupling portion 135, by way of example in the shape of a reception opening with a female thread. This is a particularly simple possibility to rotationally and operatively connect the turnstile, respectively the rotating column 105 (including a projection with a male toothing which is complementary to the female toothing) to the drive 130, respectively to the shaft member thereof.

The shaft member 135 is accommodated in the housing via a bearing in a friction-reducing manner or it has a predetermined distance to the housing 131.

As an alternative, a projection, for example in the shape of an external square, protrudes from the shaft member 135 in the direction of the non-illustrated revolving door 100, onto which square the turnstile is positively placed with a complementarily configured reception. In this case, the non-illustrated cover disc 137 may be likewise attached or conformed to the non-illustrated rotating column 105 and surround the shaft member 135 in a sealing manner, such that no or just a negligible risk of soiling exists in the area of the rotating parts.

In order for the drive 130 to be as flat as possible, despite the torque to be generated, a multipole drive motor is provided as the drive motor. The stator thereof preferably comprises electrical coils attached to the housing 131 in a ring shape, for example on the inner circumference and are interconnected for the purpose of a driving operation. The armature, respectively the rotor of the drive motor is rotationally and operatively connected to the turnstile coupling 135 and has permanent magnets disposed in a ring-shape, which are arranged to engage in an electro-magnetic driving interaction with the electrical coils upon energizing the coils. The axis of rotation of the rotor, respectively of the drive motor extends parallel or even coaxially to the axis of rotation of the turnstile coupling 135 and therefore to the axis of rotation of the rotating column 105, respectively of the entire turnstile. The rotational and operative connection may be configured by means of a component formed as a spoke wheel, as a disc or else, which couples, respectively connects the armature, respectively the rotor to the turnstile mechanically or physically in a torque-proof manner. This type of drive motor has the advantage that the electro-magnetic drive force is generated at a location remote from the axis of rotation of the motor. According to the law of the lever, the forces, generated by the drive motor in the interaction area between the stator and the rotor, are considerably lower than the torque to be applied at the motor shaft, the turnstile coupling 135, respectively the rotating column 105. This circumstance allows for utilizing flat built stators and rotors, whereby the inventive low construction height can be achieved.

Instead of permanent magnets, it is possible to provide electrical coils or parts made of ferromagnetic material.

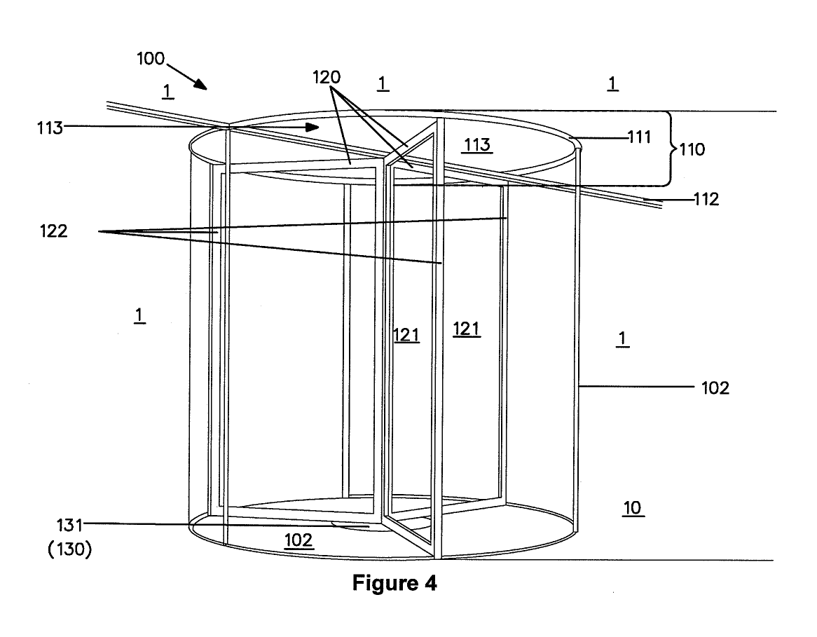

FIG. 4 shows a revolving door 100 according to a second embodiment of the invention. Like in the first embodiment, the revolving door 100 has again an underfloor disposed drive 130, which is operatively connected to the turnstile of the revolving door 100. In this case, the turnstile consists of three glass leaves 120, the frame profiles 122 thereof being attached to the rotating column 105 hidden by the frame profiles. The canopy 110 of the revolving door 100 is configured by a surrounding ring-shaped canopy frame 111, intersected by a cross member 112. Preferably two glass panes 113, having a semi-circular cross-section, are inserted between the frame 111 and the cross member 112. The revolving leaves 120, equipped with glass panels 121, are again surrounded by two drum walls 102 on both sides.

The underfloor disposed drive 130 allows for an extremely filigree canopy 110, respectively canopy structure. In particular if no additional elements such as sensors or the like are required in the upper area, visually very appealing solutions are possible.

As can be seen, such a revolving door 100 can be incorporated into glass façades, which, like in the present case, comprise glass panels 1, which may be for example disposed such as to abut against each other via joints or filigree struts 112, and a glass façade preferably extending as far as to the floor 10. As no drive needs to be mounted above the revolving door 100, the filigree appearance can continue as far as into the revolving door 100 that results in a very appealing overall visual impression.

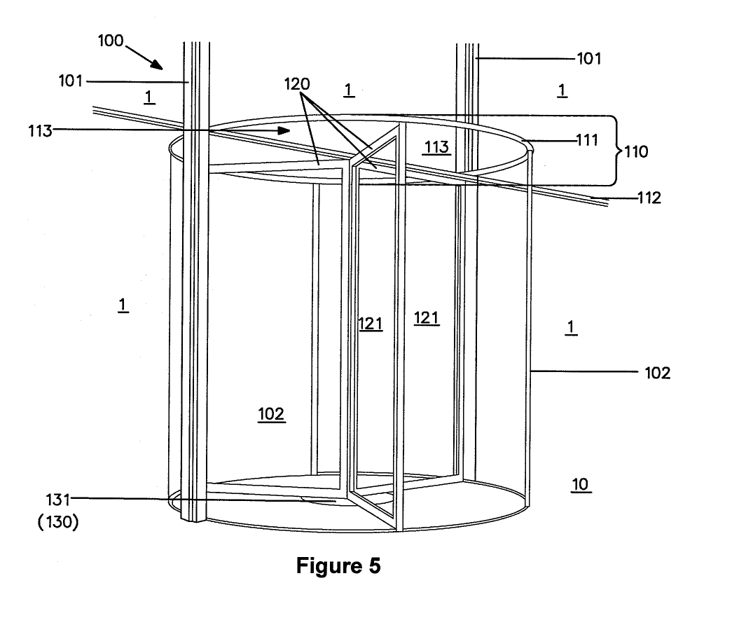

FIG. 5 shows a revolving door 100 according to a third embodiment of the invention. With regard to the revolving leaves 120, respectively the turnstile, the revolving door 100 is configured like the previous embodiments. The revolving door thus has a canopy 110 with a ring-shaped canopy frame 111. In addition, on both sides, the revolving door 100 is encased by two posts 101, which are preferably disposed in the respective centre of the respectively adjoining drum wall 102. The drive 130 is again disposed on the underside. The posts 101 and the cross member 112 separate the panels 1 of the glass façade from each other.

The invention is not limited to the previous embodiments. The canopy structure 110 may have a different configuration. For example the cross member 112 can be foregone. In addition, the ring-shaped canopy frame 111 itself may be foregone, as long as the turnstile is accommodated to freely rotate at its upper end, for example in a ceiling of the room or the like. In this case, the canopy 110 of the revolving door 100 could be configured at least partially open.

Furthermore, it is possible to provide only one glass panel 113, which is advantageously disposed in an area that corresponds to an external area of the building.

The revolving leaves 120 could have any configuration, for example thermally insulating. The same applies obviously to the drum walls 102 of the revolving door 100.

The essence of the invention is the extremely flat built drive 130, which allows for countersinking the drive 130 into the floor 10 without having to perform any work at the unfinished floor 12.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A revolving door comprising:
a turnstile of the revolving door;
a drive having a drive motor configured as a multipole electro-motor that rotationally drives the turnstile; and
an axis of rotation of the drive motor extending one of parallel and coaxially to the axis of rotation of the turnstile,
wherein the drive has a height equal to or smaller than 80 mm.

2. The revolving door according to claim 1, wherein the height of the drive motor is such that the drive has a height of equal to or smaller than 60 mm.

3. The revolving door according claim 1, further comprising a floor portion disposed between the turnstile and an unfinished floor of a building.

4. The revolving door according to claim 1, further comprising an adjusting device configured to modify an insert position of the drive in the floor.

5. The revolving door according to claim 4, wherein the adjusting device is configured to adjust the height of the drive in the floor.

6. The revolving door according to claim 4, wherein the adjusting device is configured to modify an inclination of the drive with respect to the floor.

7. The revolving door according to claim 5, wherein the adjusting device is configured to modify an inclination of the drive with respect to the floor.

8. The revolving door according claim 2, further comprising a floor portion disposed between the turnstile and an unfinished floor of a building.

9. The revolving door according to claim 8, further comprising an adjusting device configured to modify an insert position of the drive in the floor.

10. The revolving door according to claim 9, wherein the adjusting device is configured to adjust the height of the drive in the floor.

11. The revolving door according to claim 10, wherein the adjusting device is configured to modify an inclination of the drive with respect to the floor.
